(19) United States
(12) Patent Application Publication
(10) Pub. No.: US 2007/0163416 A1
(43) Pub. Date: Jul. 19, 2007

(54) CIRCULAR SAW BLADE

(75) Inventor: Kevin G. Burgess, Bolivar, OH (US)

Correspondence Address: HAHN LOESER & PARKS, LLP, One GOJO Plaza, Suite 300, AKRON, OH, 44311-1076, US

(73) Assignee: THE M. K. MORSE COMPANY, Canton, OH (US)

(21) Appl. No.: 11/622,195

(22) Filed: Jan. 11, 2007

Related U.S. Application Data
(60) Provisional application No. 60/766,361, filed on Jan. 13, 2006.

(51) Int. Cl. B23D 57/00

(52) U.S. Cl. 83/853; 83/855

(57) ABSTRACT

A carbide or cermet tip for an industrial circular saw blade is provided with improved geometric features that provide enhanced performance and longer life for the saw blade. The features include a bottom mounting surface opposite a flank relief surface, a back mounting surface opposite a leading face surface, each surface bounded by a first side surface and a second side surface; and a chip splitting groove formed on a flank relief of the tip. The ratio of the width of the chip splitting groove to the width of the tip, the width of the chip splitting groove, and the ratio of the depth of the chip splitting groove to the width of the tip are optimized. The tip is adapted to prevent contact of the chip with a gullet area of the circular steel saw body.

This application claims the benefit of U.S. provisional patent application 60/766,361, filed Jan. 13, 2006, and hereby incorporated by reference.

### TECHNICAL FIELD

The present invention relates to carbide or cermet tipped industrial circular saw blades, and in particular, to a carbide or cermet tip having improved geometric features that provide enhanced performance and longer life for the saw blade.

### BACKGROUND OF THE INVENTION

Small parts cut-off has historically been done on automatic production band saw machines or cold saw machines utilizing HSS circular saw blades. Plate sawing and large diameter billet sawing, however, were generally performed on cold saws designed to use carbide tipped circular saw blades. While cutting rates were superior to band and HSS circular sawing, the kerf loss from the carbide tool was excessive, typically in excess of 0.300″. This excessive material loss, combined with the substantial machine cost made this type of sawing unjustifiable for high volume sawing of small parts.

Many of the obstacles encountered with carbide tipped sawing have been virtually eliminated by the introduction of new improved throwaway carbide tipped circular saws utilizing a thinner kerf. As a result, the size of the machine and horse power requirements are also a fraction of what might have been required on carbide tipped cutoff saws of the past. The result has been that the carbide tipped industrial circular saws are gaining in popularity for small parts cut-off. Additional performance improvements have also been found in some applications by using a cermet tip instead of a carbide tip.

While many obstacles have been overcome, additional problems exist in improving and optimizing the performance of the carbide and cermet tipped industrial circular saws. In order to decrease the size of the chips across the kerf, chip breaking grooves have been added to the flank on the carbide tips. A chip splitting groove is used in saw blade designs to split the chip into two pieces. These two pieces are narrower than the width of the cut, or kerf. Without the grooves, a single chip would be the same width as the kerf and would rub on the sides of the cut, creating friction. This friction creates heat, and requires extra power from the saw machine. Typically the chip breaking grooves are staggered such that one groove is nearer one side of the carbide tip and the next circumferential carbide tip has a groove nearer the other side of the carbide tip. There is no overlap of the grooves from one tip to the next in order to minimize the depth of cut required by the following carbide tip to remove the material that was not cut at the chip breaking groove by the previous circumferential carbide tip. The staggered chip breaking grooves have provided performance enhancement of the saw blade, however, the groove removes material from the tip making the tip weaker, especially on the short side, or the side nearest the groove.

A problem with existing prior art tips is that the chip breaking groove is too wide. This results in a larger uncut area in the work material which must be cut by the following tip. This results in a high stress zone on the cutting edge eventually leading to the catastrophic failure of the tip. Another result of the wide chip breaking groove is that the distance between the sides of the tip and the chip breaking groove is relatively small thus creating a weak area of the tip that is susceptible to fatigue failure. The ratio of the width of the groove to the width of the carbide tip of prior art carbide tips is generally about 1:5 representing a groove width of about 0.020 inches on a 0.103 inch width tip. This means that about 20% of each tip is not cutting the work piece and that the next tip will have to remove a chip having an area of double thickness corresponding to 20% of the width of the tip.

Another problem with the chip breaker grooves used on existing prior art carbide tips is that the groove depth that is too deep and further weakens the tip by removing additional material from the tip. The material removal is further exacerbated by the wide groove. The ratio of the depth of the chip splitting groove to the width of the carbide tip for prior art circular saws is generally about 1:12.

Still another problem with the existing prior art tips involves the geometry of the leading face of prior art tips. The prior art tips have a geometry that allows the chips to be directed into contact with the gullet of the saw blade. This wears the saw blade at the gullet and produces additional friction/heat that can result in a weak area limiting the life of the saw blade

Finally, there are additional problems with existing prior art carbide tips related to the size of the carbide tip itself. The carbide tips are brazed to the saw blade body. Using a tip that is too large causes stresses in the braze joint due to the difference in thermal expansion coefficients between the steel of the blade body and the cermet or carbide of the tip. Using a tip that is too small reduces the surface area of the braze joint, creating a weak braze joint.

While great strides have been made in the development of carbide/cermet tipped saw blades for high volume sawing of small parts, there still exists room for additional improvements in performance in terms of feed rates and blade life. It would therefore be advantageous to produce an improved blade that will overcome one or more of the deficiencies identified in the prior art and that will further increase the use of carbide/cermet tipped saw blades for industrial high volume sawing of small parts.

### SUMMARY OF THE INVENTION

The present invention overcomes at least one disadvantage of the prior art by providing a tip for a circular saw, the tip comprising: a bottom mounting surface opposite a flank relief surface, a back mounting surface opposite a leading face surface, each surface bounded by a first side surface and a second side surface; a chip splitting groove formed on a flank relief of the tip, wherein the ratio of the width of the chip splitting groove to the width of the tip is generally 1:7 or less and the width of the chip splitting groove is 0.014 inches or less.

At least one advantage is also provided by a tip for a circular saw, the tip comprising: a bottom mounting surface opposite a flank relief surface, a back mounting surface opposite a leading face surface, each surface bounded by a first side surface and a second side surface; a chip splitting groove formed on a flank relief of the tip, wherein the ratio of the depth of the chip splitting groove to the width of the tip is generally 1:17 or less.

At least one advantage is also provided by a circular saw comprising: a generally circular, steel saw body; and a plurality of carbide or cermet tips spaced about the outer periphery of the circular saw body and attached to the saw body, wherein each tip has a chip splitting groove formed on a flank relief of the tip, wherein the ratio of the width of the chip splitting groove to the width of the tip is generally 1:7 or less and the width of the chip splitting groove is 0.014 inches or less.

At least one advantage is also provided by a circular saw comprising: a generally circular, steel saw body; and a plurality of carbide or cermet tips spaced about the outer periphery of the circular saw body and attached to the saw body, wherein each tip has a chip splitting groove formed on a flank relief of the tip, wherein the ratio of the depth of the chip splitting groove to the width of the tip is generally 1:17 or less.

At least one advantage is also provided by a circular saw comprising: a generally circular steel saw body; and a plurality of carbide or cermet tips each having a leading face opposite a back mounting face, wherein the leading face of each tip comprises, from top to bottom: a planar rake surface formed at negative rake angle, a second planar surface extending from a bottom of the rake surface toward the back mounting face of the tip at a second angle, a third planar surface extending from the bottom of the second planar surface at a third angle away from the back mounting face of the tip and forming an angle greater than ninety degrees and less than one hundred eighty degrees with the second planar surface, a fourth planar surface generally parallel to the back mounting face of the tip, each tip further comprising a concave radius between the second planar surface and the third planar surface, and a convex radius between the third planar surface and the fourth planar surface; wherein each tip is adapted to prevent contact of a chip from a work piece with a gullet area of the circular steel saw body.

These and other advantages will be apparent upon a review of the drawings and detailed description of the invention.

### BRIEF DESCRIPTION OF THE DRAWINGS

The invention will now be described in further detail with reference to the accompanying drawings, in which:

FIG. 1 is a side view of a saw blade in accordance with an embodiment of the present invention;

FIG. 2 is a perspective view of a tip used in the saw blade of FIG. 1;

FIG. 3 a partial front face view of a tip mounted on a saw blade body showing the groove width to tip width ratio and the groove depth to tip width ratio;

FIG. 4 is a diagram showing the cross-section of the chips that will be removed from a work piece, also shown in cross-section, by a tip shown in a front view;

FIG. 5 is a picture of a front perspective view of an actual tip of the present invention showing the increased wear caused by chip splitting grooves;

FIG. 6 is a side view of a tip used in the saw blade of FIG. 1;

FIG. 7 is a partial side view of a the saw blade of FIG. 1 wherein the chip formed by the tip is curled and fills the gullet without contacting the saw blade;

FIG. 8 is partial side view of a prior art saw blade wherein the chip formed by the tip contacts the gullet of the saw blade;

FIG. 9 is a partial front face view of a tip mounted on a saw blade body showing top to bottom relief;

FIG. 10 is a partial top view of a tip mounted on a saw blade body showing front to back relief; and

FIG. 11 shows actual test results from testing of saw blades in accordance with the present invention and prior art saw blades.

### DETAILED DESCRIPTION OF THE INVENTION

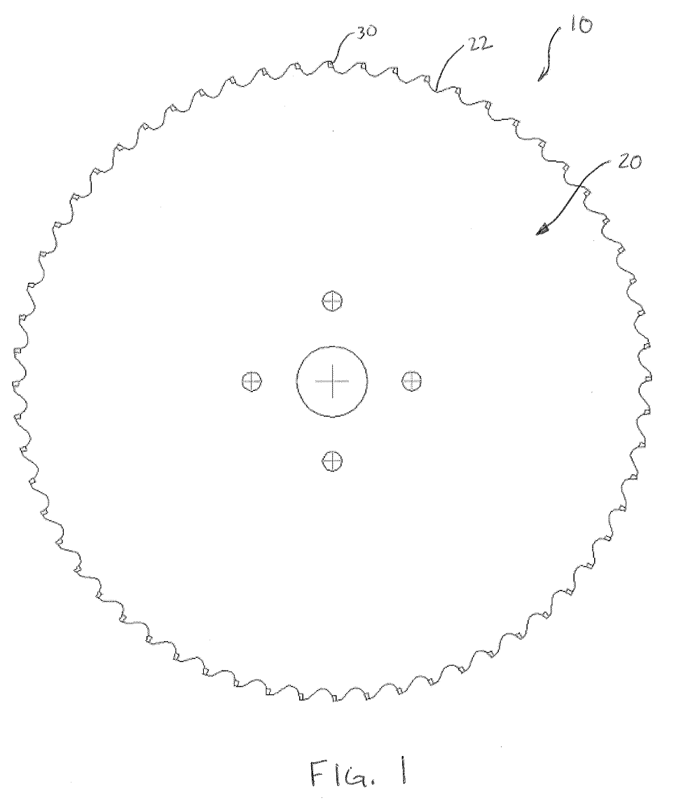

This invention will now be described in detail with reference to various embodiments thereof. Referring now to FIG. 1, the circular saw blade 10 of the present invention is shown. Circular saw 10 comprises a generally circular, steel saw body 20; and a plurality of tips 30 spaced about the outer periphery of the circular saw body 20 and attached to the saw body 20. The tips 30 are each made of a carbide or cermet material. The tips 30 are typically attached to the saw body by a brazing process as is well known in the art. Between the tips 30 are gullets 22 formed in the saw body to allow room for the chips formed during cutting.

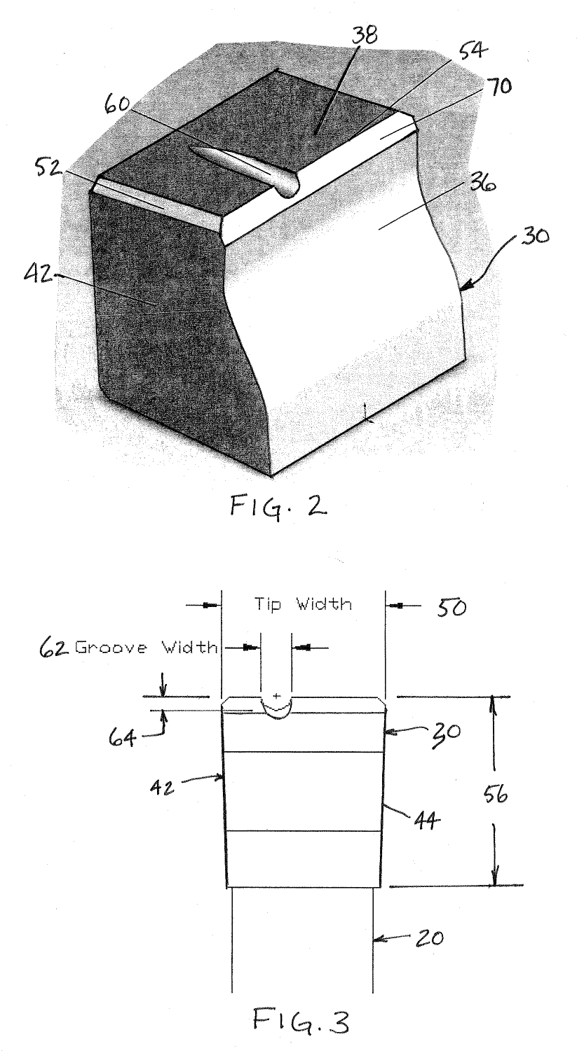

The tip 30 is shown in a perspective view in FIG. 2. The tip 30 includes a bottom mounting surface 32 and a back mounting surface 34 that provide the mounting surfaces for attaching the tip to the saw body 20. The tip includes a leading surface face 36 opposite the back mounting surface 34 and a flank surface 38 opposite the bottom mounting surface 32. The leading face 36 is adapted to prevent contact of the chip with the trailing gullet 22 of the saw body 20 as will be discussed in greater detail below. The flank surface 36 provides a clearance relief at a relief angle. The mounting surfaces 32, 34, and the flank and lead surfaces 36, 38 are each bounded by side surfaces 42, 44 which define the width 50 of the tip 30 which corresponds to the width of the cut also referred to as the kerf. A corner chamfer 52 is shown at the intersection of the flank 26 and the sides 42, 44 of the tip 30. A cutting edge 54 of the tip 30 is formed at the intersection of the lead surface 36 and the flank surface 38.

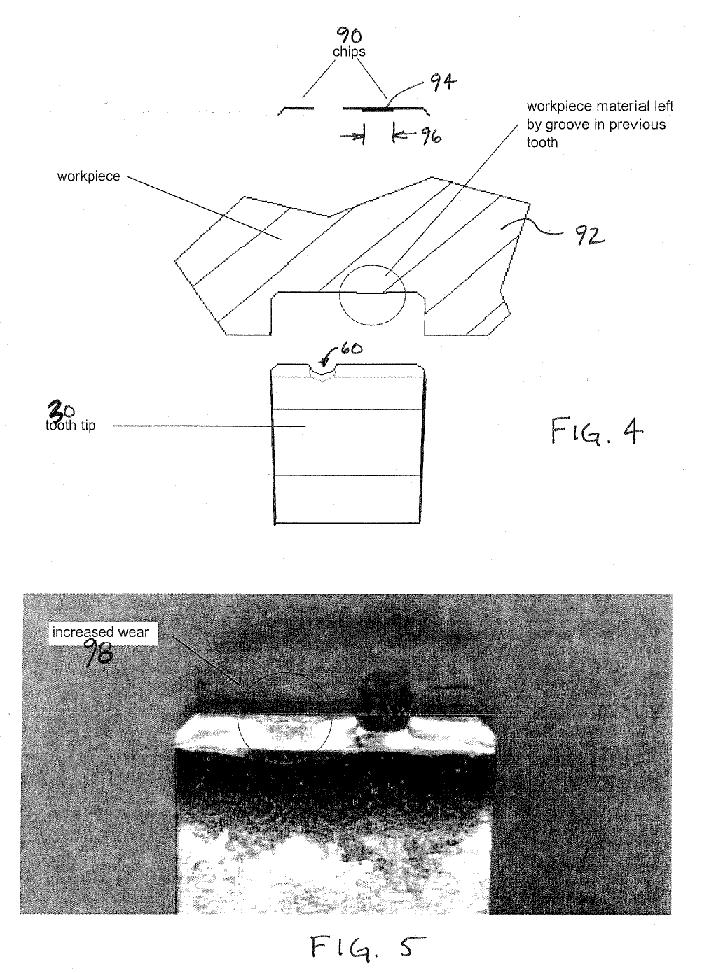

A chip splitting groove 60 is formed in the flank surface 36 of the tip 30, the groove 60 having a width 62 and a depth 64 at the cutting edge 54. The width 62 of the groove 60 is significantly narrower than that of the prior art tips. The characteristic of the tip groove width of the present invention is defined as the ratio of the groove width 62 to the width of the tip 50 and is generally 1:7 or less, wherein the groove width is 0.014 inches or less. The characteristic of the tip groove depth of the present invention is defined as the ratio of the groove depth 64 to the width of the tip 50 and is generally 1:17 or less. These relationships are best shown in FIG. 3. As discussed with regard to the prior art, if the groove is too large, it will weaken the structural integrity of the tip. The groove 60 of the present invention reduces at least one of the depth and the width of the groove and preferably both, so that the tip 20 retains much of its strength. A narrow groove allows for a more constant uncut chip thickness across the width of the cut. As previously mentioned, the groove 60 creates a thicker uncut chip that the trailing tooth must cut to remove. The chip formation is best shown in FIG. 4, wherein the relationship of the chips 90 to be cut on the work piece 92 are shown in relation to the tip 30 and groove 60. The thick section of the chip 90 is designated 94 and has a width 96 corresponding to the groove width 62. Having to remove the thick portion of the chip increases the depth of cut on the following tip which causes added stress to the tip. The results of these increased stresses can easily be seen in standard inspections as shown in the picture of FIG. 5 as designated at 98 on the negative rake face 70 of the tip 30. The narrow groove 60 reduces the area affected by this thicker area.

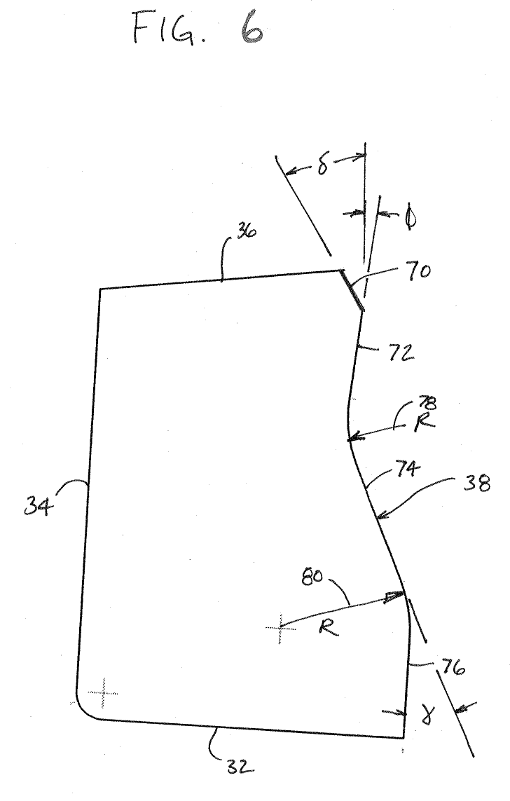

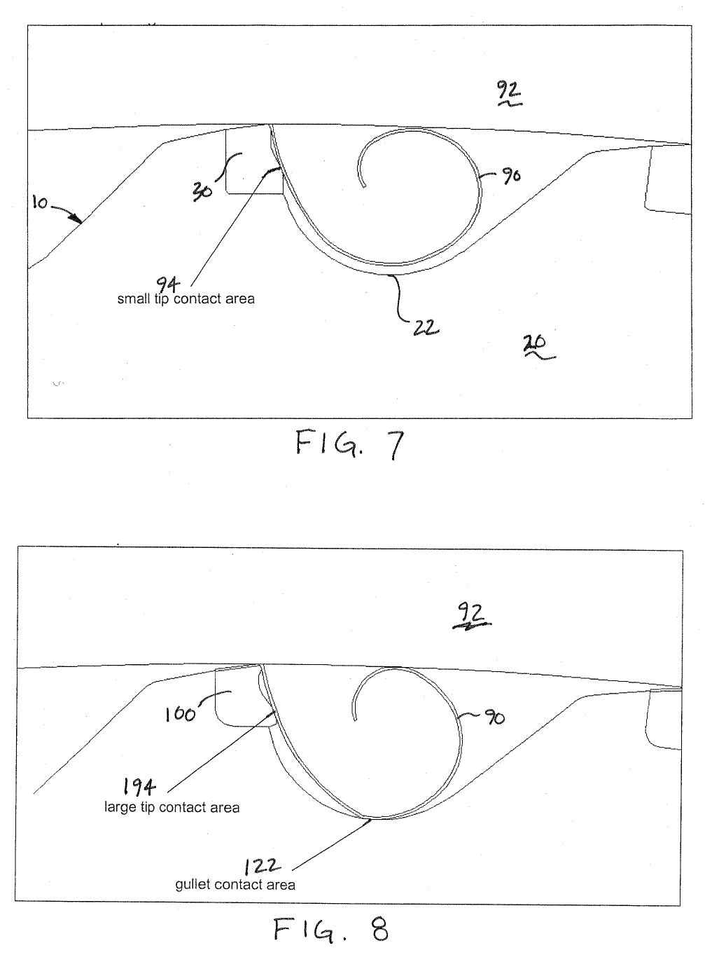

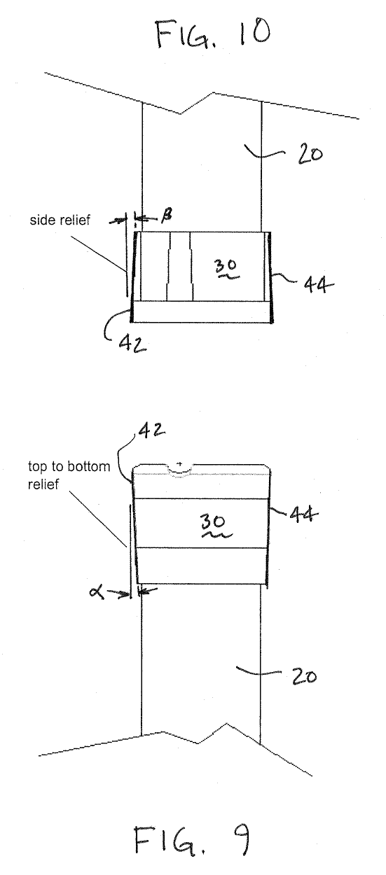

Another feature of the present invention is the leading face 38 of each tip 30 which is referred to generally as the “spoon” face as best seen in FIG. 6. The spoon face 38 comprises, from top to bottom a) a rake surface 70 formed at a negative rake angle δ; b) a second planar surface 72 extending from a bottom of the rake surface 70 toward the back mounting face 34 of the tip 30 at a second angle φ; c) a third planar surface 74 extending from the bottom of the second planar surface 72 at a third angle γ away from the back mounting face 34 of the tip 30 and forming an angle ψ greater than ninety degrees and less than one hundred eighty degrees with the second planar surface 72; d) a fourth planar surface 76 generally parallel to the back mounting face 34 of the tip 30. Each tip 30 further comprises e) a concave radius 78 between the second planar surface 72 and the third planar surface 74; and f) a convex radius 80 between the third planar surface 74 and the fourth planar surface 76. As shown in FIG. 7, the spoon face 38 is optimally designed to guide and curl the chip 90 of the work piece 92 so that it fills the gullet 22 and helps prevent contact of the chip 90 with the gullet 22. This prevents excessive rubbing of the chip in the gullet thus minimizing friction/heat that reduce the life of the saw blade 10. The geometry of the spoon face 38 also reduces the contact area 94 of the chip 90 and the tip 30, also decreasing friction/heat of the saw blade 10. In comparison, FIG. 8 shows a prior art tip 100 wherein the chip 90 contacts the gullet 122 and the tip 100 has a large contact area 194 with the chip 90.

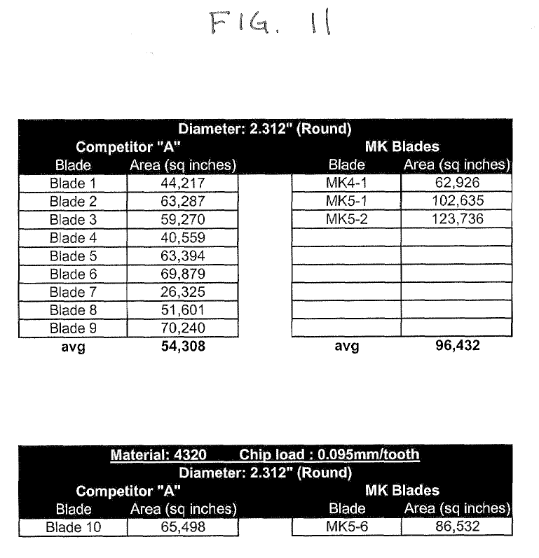

In one embodiment of the present invention as best shown in FIGS. 9 and 10, the tip 30 has a compound side relief. The compound side relief is from top-to-bottom and from front-to-back. The side relief angle α from top to bottom is typically greater than one degree as shown in FIG. 8 while the side relief angle β from front to back is greater than zero degrees as shown in FIG. 9. The compound relief angles α, β on the sides 42, 44 of the tip 30 improve the efficiency of the cut by reducing rubbing of the sides 42, 44 against the material being cut. Side rubbing produces heat which leads to increased wear and the eventual failure of the tip.

In one embodiment of the tip 30 of the present invention, it has been determined that the optimum ratio of the height 56 of the tip 30 to the width 50 of the tip 30 is between 1.20 to 1.30 as best shown in FIG. 3. This size provides a optimal strength for the brazed joint while minimizing the stresses in the brazed joint due to the difference in thermal expansion coefficients between the steel of the blade body and the cermet or carbide of the tip.

Referring now to the test results shown in FIG. 10, the saw blades 10 of the present invention “MK Blades” have been tested in operation against prior art saw blades from a leading competitor “COMPETITOR A”. The blades were used to cut 4320 round steel bars having a 2.312 inch diameter at a chip load of 0.085 mm/tooth. The blades were run until either the blade failed competitor blades) or when the sparks during the cut revealed that the blade was close to failure blades 10 of the current invention). As can be seen from the results, the average area cut by the saw blades 10 of the present invention was 96,432 sq. inches and the average area cut by the competitor's blades was 54,308 sq. inches. This represents an improvement of over 77%.

Limited additional testing was completed at higher chip loads which also showed an improvement in life over the prior art blades as depicted at the bottom of FIG. 10. Although only one blade each was run, the improvement trend continued and will be supplemented by additional testing.

Although the present invention has been described above in detail, the same is by way of illustration and example only and is not to be taken as a limitation on the present invention.

1. A circular saw blade comprising:
a generally circular, steel saw body; and
a plurality of carbide or cermet tips spaced about the outer periphery of the circular saw body and attached to the saw body, wherein each tip has a chip splitting groove formed on a flank relief of the tip, wherein the ratio of the width of the chip splitting groove to the width of the tip is generally 1:7 or less and the width of the chip splitting groove is 0.014 inches or less.

2. The circular saw blade of claim 1, wherein the ratio of the depth of the chip splitting groove to the width of the tip is generally 1:17 or less.

3. The circular saw blade of claim 1, wherein the ratio of the height of the tip to the width of the tip is between 1.20 to 1.30.

4. The circular saw blade of claim 1, wherein the tip is adapted to prevent contact of the chip with a gullet area of the circular steel saw body.

5. The circular saw blade of claim 1, wherein the tip has a side relief angle of greater that one degree from top to bottom.

6. The circular saw blade of claim 5, wherein the tip has a side relief angle of greater that zero degree from front to back.

7. The circular saw blade of claim 4, wherein the plurality of tips each having a leading face opposite a back mounting face, wherein the leading face of each tip comprises, from top to bottom:
a rake surface formed at negative rake angle,
a first planar surface extending from a bottom of the rake surface toward the back mounting face of the tip at a first angle,
a second planar surface extending from the bottom of the first planar surface at an second angle away from the back mounting face of the tip and forming an angle greater than ninety degrees and less than one hundred eighty degrees with the first clearance surface,
a third planar surface generally parallel to the back mounting face of the tip,
each tip further comprising a concave radius between the first planar surface and the second planar surface, and a convex radius between the second planar surface and the third planar surface.

8. A tip for a circular saw blade, the tip comprising:
a bottom mounting surface opposite a flank relief surface, a back mounting surface opposite a leading face surface, each surface bounded by a first side surface and a second side surface;
a chip splitting groove formed on a flank relief of the tip, wherein the ratio of the width of the chip splitting groove to the width of the tip is generally 1:7 or less and the width of the chip splitting groove is 0.014 inches or less.

9. The tip of claim 8, wherein the ratio of the depth of the chip splitting groove to the width of the tip is generally 1:17 or less.

10. A circular saw blade comprising:
a generally circular steel saw body; and
a plurality of carbide or cermet tips each having a leading face opposite a back mounting face, wherein the leading face of each tip comprises, from top to bottom:
a planar rake surface formed at negative rake angle,
a second planar surface extending from a bottom of the rake surface toward the back mounting face of the tip at a first angle,
a third planar surface extending from the bottom of the second planar surface at an second angle away from the back mounting face of the tip and forming an angle greater than ninety degrees and less than one hundred eighty degrees with the second planar surface,
a fourth planar surface generally parallel to the back mounting face of the tip,
each tip further comprising a concave radius between the second planar surface and the third planar surface, and a convex radius between the third planar surface and the fourth planar surface;
wherein each tip is adapted to prevent contact of a chip from a work piece with a gullet area of the circular steel saw body.

11. The circular saw blade of claim 10, wherein the second planar surface is at an angle generally between 3 and 10 degrees with the back mounting surface.

12. The circular saw blade of claim 10, wherein the third planar surface is at an angle generally between 15 and 35 degrees with the back mounting surface.

13. The circular saw blade of claim 10, wherein at least one of the radii is between 0.020 inch and 0.060 inch.

14. A circular saw blade comprising:
a generally circular, steel saw body; and
a plurality of carbide or cermet tips spaced about the outer periphery of the circular saw body and attached to the saw body, wherein each tip has a chip splitting groove formed on a flank relief of the tip, wherein the ratio of the depth of the chip splitting groove to the width of the tip is generally 1:17 or less.

15. The circular saw blade of claim 14, wherein the tip is adapted to prevent contact of the chip with a gullet area of the circular steel saw body.

16. The circular saw blade of claim 15, wherein the plurality of tips each having a leading face opposite a back mounting face, wherein the leading face of each tip comprises, from top to bottom:
a rake surface formed at negative rake angle,
a first planar surface extending from a bottom of the rake surface toward the back mounting face of the tip at a first angle,
a second planar surface extending from the bottom of the first planar surface at an second angle away from the back mounting face of the tip and forming an angle greater than ninety degrees and less than one hundred eighty degrees with the first clearance surface,
a third planar surface generally parallel to the back mounting face of the tip,
each tip further comprising a concave radius between the first planar surface and the second planar surface, and a convex radius between the second planar surface and the third planar surface.

17. A tip for a circular saw, the tip comprising:
a bottom mounting surface opposite a flank relief surface, a back mounting surface opposite a leading face surface, each surface bounded by a first side surface and a second side surface;
a chip splitting groove formed on a flank relief of the tip, wherein the ratio of the depth of the chip splitting groove to the width of the tip is generally 1:17 or less.

18. The tip of claim 17, wherein the ratio of the width of the chip splitting groove to the width of the tip is generally 1:7 or less.

19. The tip of claim 17, wherein the width of the chip splitting groove is 0.014 inches or less.

20. The tip of claim 17, wherein the leading face comprises, from top to bottom:
a planar rake surface formed at negative rake angle,
a second planar surface extending from a bottom of the rake surface toward the back mounting face of the tip at a first angle,
a third planar surface extending from the bottom of the second planar surface at an second angle away from the back mounting face of the tip and forming an angle greater than ninety degrees and less than one hundred eighty degrees with the second planar surface,
a fourth planar surface generally parallel to the back mounting face of the tip,
the tip further comprising a concave radius between the second planar surface and the third planar surface, and a convex radius between the third planar surface and the fourth planar surface.
